(19) United States
(12) Patent Application Publication
(10) Pub. No.: US 2007/0120490 A1
(43) Pub. Date: May 31, 2007

(54) Plasma display panel

(76) Inventor: Dong-Hyun Kim, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/604,548

(22) Filed: Nov. 27, 2006

(30) Foreign Application Priority Data
Nov. 30, 2005 (KR) 10-2005-0115870

(51) Int. Cl. H01J 17/02

(52) U.S. Cl. 313/610

(57) ABSTRACT

Provided is a plasma display panel that includes a first substrate, a second substrate facing the first substrate, a pair of discharge electrode lines which are disposed between the first substrate and the second substrate and comprise a first discharge electrode line formed by connecting a plurality of sub-electrode lines and a second discharge electrode line that faces the first discharge electrode line and is formed by connecting a plurality of sub-electrode lines, and dielectric layers that bury the discharge electrode lines. Since the dielectric layers include B₂O₃ and BaO, yellowness caused by the migration of a metal component included in the discharge electrode lines into the dielectric layers during a firing process can be prevented.

### CROSS-REFERENCE TO RELATED PATENT APPLICATION

This application claims the benefit of Korean Patent Application No. 10-2005-115870, filed on Nov. 30, 2005, in the Korean Intellectual Property Office, the disclosure of which is incorporated herein in its entirety by reference.

### BACKGROUND OF THE INVENTION

1. Field of the Invention

The present embodiments relate to a plasma display panel, and more particularly, to a plasma display panel in which yellowing is prevented by changing the composition of a dielectric layer that buries a discharge electrode line.

2. Description of the Related Art

Conventionally, plasma display panels are flat display devices that display desired numbers, letters, or a graphic by exciting a phosphor material in a phosphor layer by ultraviolet rays generated by a discharge of a discharge gas filled between two substrates on which a plurality of electrodes are formed.

FIG. 1 is a partially cutaway exploded perspective view illustrating a conventional plasma display panel 100. The plasma display panel 100 includes a first substrate 111 and a second substrate 161 facing the first substrate 111. A first discharge electrode line 112, which acts as an X electrode, and a second discharge electrode line 113, which acts as a Y electrode, form a sustain discharge electrode line pair, a first dielectric layer 114 that buries the first and second discharge electrode lines 111 and 113, and a protective layer 115 are formed on an inner surface of the first substrate 111. A plurality of address electrode lines 162 crossing the sustain discharge electrode line pair and a second dielectric layer 163 that buries the address electrode lines 162 are formed on an inner surface of the second substrate 161.

The first discharge electrode line 112 is composed of a plurality of first transparent electrode lines 112a and a plurality of first bus electrode lines 112b disposed along an edge of the first transparent electrode lines 112a. The second discharge electrode line 113 is composed of a plurality of second transparent electrode lines 113a and a plurality of second bus electrode lines 113b disposed along an edge of the second transparent electrode lines 113a.

The first transparent electrode lines 112a of the first discharge electrode lines 112 and the second transparent electrode lines 113a of second discharge electrode lines 113 are formed of a transparent conductive film, and the first bus electrode lines 112b of the first discharge electrode line 112 and the second bus electrode lines 113b and 113a of second discharge electrode line 113 are formed of a metal having high conductivity to increase the conductivity of the first transparent electrode lines 112a and the second transparent electrode lines 113a. Also, the first dielectric layer 114 and the second dielectric layer 163 are formed of a high dielectric material that includes PbO.

A plurality of barrier ribs 164 that define discharge cells are disposed between the first and second substrates 111 and 161 and phosphor layers 165 of red, green, and blue color are coated on inner sides of the barrier ribs 164.

In the conventional plasma display panel 100 having the above structure, the discharge cells are selected at intersections of the second discharge electrode line 113 and the address electrode lines 162 by respectively applying electrical signals to the second discharge electrode line 113 and the address electrode lines 162 and a surface discharge is generated from a surface of the first substrate 111 by alternately applying an electrical signal to the first and second discharge electrode lines 112 and 113 in order to generate ultraviolet rays. Visible light is emitted from the red, green, and blue color phosphor layers 165 coated in the selected discharge cells. Therefore, the plasma display panel 100 can display a stationary image or a moving image.

In the conventional plasma display panel 100, in order to avoid blocking of the propagation of the visible light emitted from the phosphor layers 165 towards the first substrate 111, the first transparent electrode lines 112a and the second transparent electrode lines 113a are formed of a transparent conductive film such as indium tin oxide (ITO) film. However, the transparent conductive film generally has high resistance, a large voltage drop in a lengthwise direction resulting in high driving power consumption, and a long response time.

Therefore, the first bus electrode lines 112b and the second bus electrode lines 113b which are formed of an opaque metal having high electrical conductivity are respectively formed along edges of the first transparent electrode lines 112a and the second transparent electrode lines 113a.

In this way, the plurality of first and second transparent electrode lines 112a and 113a and the plurality of first and second bus electrode lines 112b and 113b must be separately formed on the first substrate 111. Therefore, manufacturing costs increase due to the expensive transparent electrode lines 112a and 113a. Also, the first and second transparent electrode lines 112a and 113a and the first and second bus electrode lines 112b and 113b must be separately manufactured, thus, making the manufacturing process complicated, thereby increasing manufacturing time.

Therefore, a structure in which a transparent electrode line is removed from the substrate and a bus electrode line is only selectively patterned, namely, an ITO-free type of structure has been recently studied. In such a structure where the bus electrode line is only employed as the discharge electrode line, the line width of the bus electrode line is formed to be wider than the bus electrode line in a panel structure in which the bus electrode line overlaps with the transparent electrode line.

However, if the bus electrode line is only formed, then Ag, which constitutes the main component of the bus electrode line, diffuses into a dielectric layer that buries the bus electrode line when the bus electrode line is fired, that is, yellowing occurs. The yellowing is caused by PbO included in the dielectric layer since PbO becomes a migration path of a component of an electrode formed of a metal like Ag during firing the dielectric layer.

That is, in the prior art, PbO is included in the dielectric layer in order to reduce the melting pint of the dielectric layer. Meanwhile, the size of the Pb²⁺ ion in PbO is similar to the size of the Ag²⁺ ion. Therefore, the Ag²⁺ ion that diffuses into the dielectric layer becomes a neutral metal by replacing the Pb²⁺ ion in the dielectric layer through an active electron donor-receiver reaction (mainly a reduction reaction), thereby causing yellowing.

Accordingly, in a structure of a plasma display panel that employs a single discharge electrode line, especially, an ITO-free type electrode, the diffusion phenomenon of a metal atom of the single discharge electrode line into a dielectric layer causes a need for yellowing to be minimized.

### SUMMARY OF THE INVENTION

The present embodiments provide a plasma display panel in which yellowing is prevented by forming the dielectric layer without PbO which prevents the diffusion of a metal atom of the discharge electrode into a dielectric layer.

According to an aspect of the present embodiments, there is provided a plasma display panel comprising: a first substrate; a second substrate facing the first substrate; a pair of discharge electrode lines that are disposed between the first substrate and the second substrate and comprise a first discharge electrode line formed by connecting the plurality of sub-electrode lines and a second discharge electrode line that faces the first discharge electrode line and is formed by connecting a plurality of sub-electrode lines; and dielectric layers that bury the discharge electrode lines, wherein the dielectric layers comprise B₂O₃ and BaO.

The content of B₂O₃ in the dielectric layers may be from about 10 to about 60% of the total composition of the dielectric layers.

The content of BaO in the dielectric layers may be from about 10 to about 60% of the total composition of the dielectric layers.

The dielectric layers may comprise at least one material selected from the group consisting of Al₂O₃, ZnO, SnO, and P₂O₅.

The material selected from the group consisting of Al₂O₃, ZnO, SnO, and P₂O₅ may from about 10 to about 30% of the total composition of the dielectric layers.

The discharge electrode lines may be ITO-free type electrodes.

According to another aspect of the present embodiments, there is provided a plasma display panel comprising: a first substrate; a second substrate facing the first substrate; barrier ribs disposed between the first and second substrates in order to define a plurality of discharge cells; a pair of sustain discharge electrode lines that comprise a first discharge electrode line that is disposed between the first and second substrates and is formed by connecting a plurality of sub-electrode lines and a second discharge electrode line that faces the first discharge electrode line and is formed by connecting a plurality of sub-electrode lines, and wherein a sustain discharge is generated between the first discharge electrode line and the second discharge electrode line; address electrode lines that are perpendicular to the pair of sustain discharge electrode lines in order to generate address discharges with one of first and second discharge electrode lines of the pair of sustain discharge electrode lines; and dielectric layers that respectively bury the pair of sustain discharge electrode lines and the address electrode lines; and phosphor layers of red, green, and blue color formed in the discharge cells, wherein the dielectric layers comprise B₂O₃ and BaO.

The content of B₂O₃ in the dielectric layers may from about 10 to about 60% of the total composition of the dielectric layers.

The content of BaO in the dielectric layers may be from about 10 to about 60% of the total composition of the dielectric layers.

The dielectric layers may additionally comprise at least one material selected from the group consisting of Al₂O₃, ZnO, SnO, and P₂O₅.

The content of the material selected from the group consisting of Al₂O₃, ZnO, SnO, and P₂O₅ in the dielectric layers may from about 10 to about 30% of the total composition of the dielectric layers.

The pair of sustain discharge electrode lines and the address electrode lines may be ITO-free type of electrodes.

### BRIEF DESCRIPTION OF THE DRAWINGS

The above and other features and advantages of the present embodiments will become more apparent by describing in detail exemplary embodiments thereof with reference to the attached drawings in which:

FIG. 1 is a partially cutaway exploded perspective view illustrating a conventional plasma display panel;

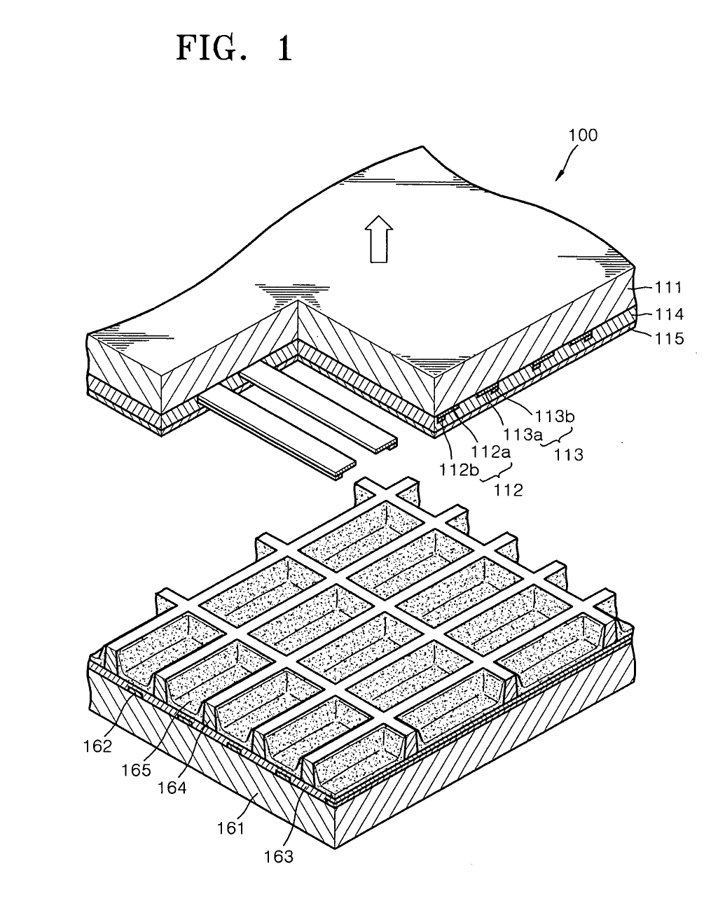

FIG. 2 is a partially cutaway perspective view of a plasma display panel according to an embodiment;

FIG. 3 is a cross-sectional view taken along the line I-I of the plasma display panel of FIG. 2, according to an embodiment; and

FIG. 4 is a plan view of the plasma display panel of FIG. 2, according to an embodiment.

### DETAILED DESCRIPTION OF THE INVENTION

A plasma display panel according to the present embodiments will now be described more fully with reference to the accompanying drawings in which exemplary embodiments are shown.

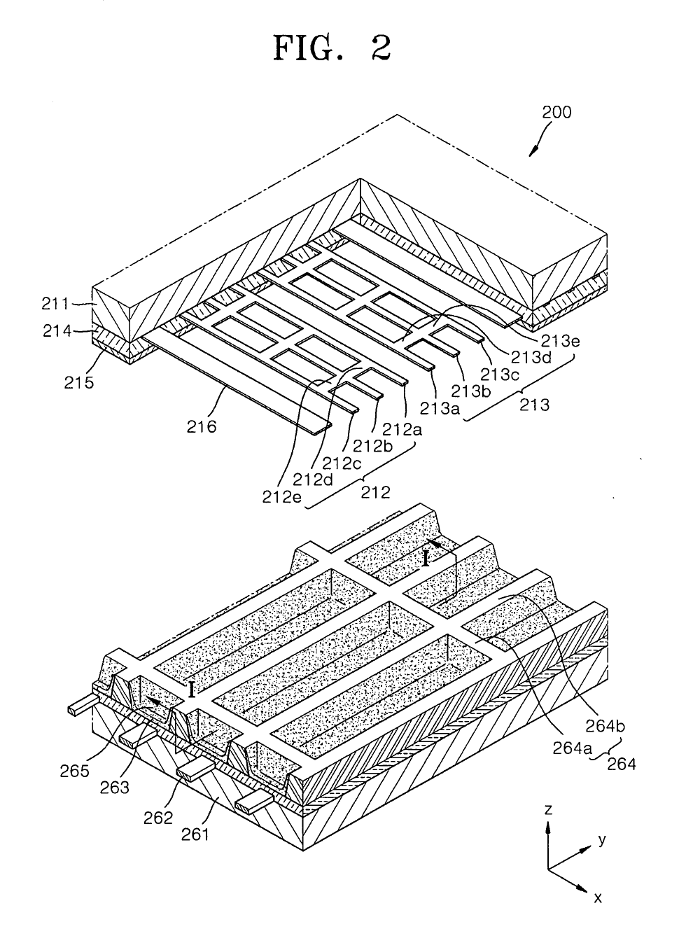

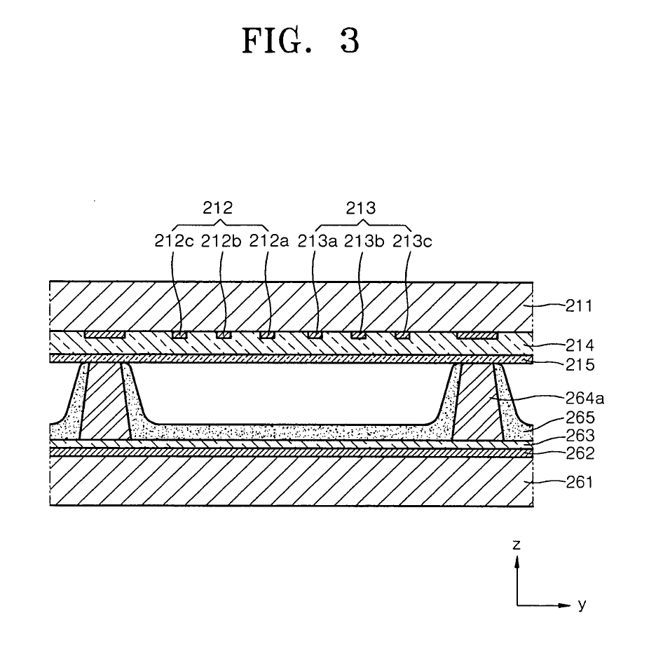

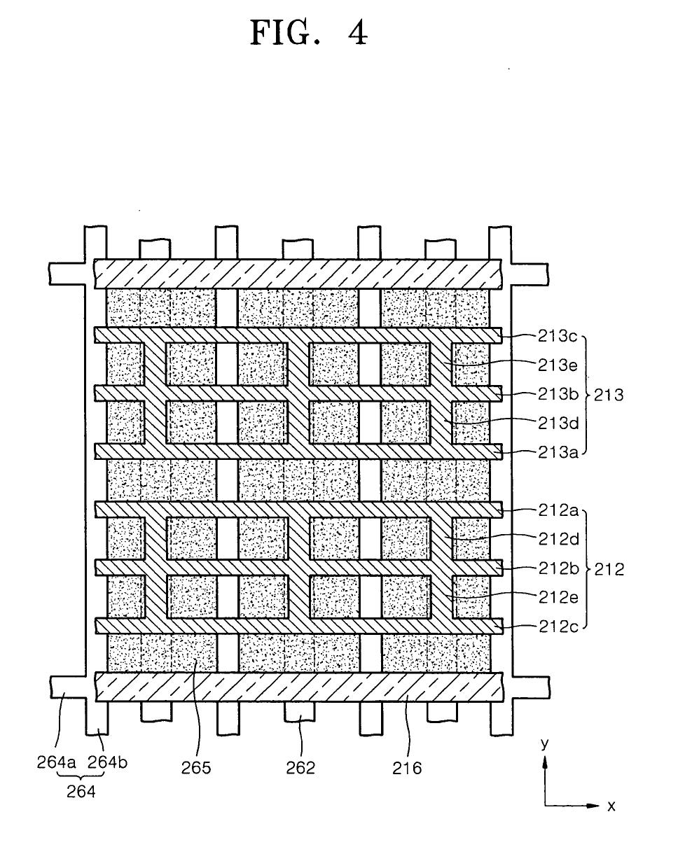

FIG. 2 is a partially cutaway perspective view of a plasma display panel 200 according to an embodiment. FIG. 3 is a cross-sectional view taken along the line I-I of the plasma display panel 200 of FIG. 2, and FIG. 4 is a plan view of the plasma display panel of FIG. 2, according to an embodiment.

Referring to FIGS. 2 through 4, the plasma display panel 200 includes a first substrate 211 and a second substrate 261 facing the first substrate 211. A sealant (not shown) such as a frit glass is coated on edges of a surface of the first substrate 211 facing the second substrate 261, and the first and second substrates 211 and 261 are thermally bonded to seal a space therebetween.

First discharge electrode lines 212 are disposed in a direction parallel to the X direction of the plasma display panel 200 and, in each discharge cell, second discharge electrode lines 213 are disposed facing the first discharge electrode lines 212 on an inner surface of the first substrate 211. The second discharge electrode lines 213 are disposed in the same direction as the first discharge electrode lines 212 and have a substantially symmetrical shape. The first discharge electrode lines 212 and the second discharge electrode lines 213 are alternately disposed in a Y direction of the plasma display panel 200.

The first discharge electrode lines 212 and the second discharge electrode lines 213 are buried in a first dielectric layer 214. A protective layer 215 such as, for example, an MgO film is formed on a surface of the first dielectric layer 214 to protect the first dielectric layer 214 and to increase the emission of secondary electrons.

A plurality of address electrode lines 262 crossing the first discharge electrode lines 212 and the second discharge electrode lines 213, that is, in the Y direction of the plasma display panel 200 are disposed on an inner surface of the second substrate 261. The address electrode lines 262 are buried in a second dielectric layer 263.

Accordingly, in a unit discharge cell, one sustain discharge electrode pair composed of the first discharge electrode lines 212 and the second discharge electrode lines 213 and the address electrode line 262 crossing the sustain discharge electrode pair are disposed. This structure corresponds to a three-electrode surface discharge type plasma display panel, but the structure of the present embodiments is not limited thereto.

Barrier ribs 264 that define a space between the first and second substrates 211 and 261 into a plurality of discharge cells together with the first and second substrates 211 and 261 are formed between the first and second substrates 211 and 261. The barrier ribs 264 are formed of a dielectric material such as a glass paste to which various fillers are added.

The barrier ribs 264 include first barrier ribs 264a disposed in an X direction of the plasma display panel 200, that is, in a direction crossing to the address electrode lines 262 and second barrier ribs 264b disposed in a Y direction of the plasma display panel 200, that is, in a direction parallel to the address electrode lines 262. The second barrier ribs 264b define a discharge cell by extending perpendicular from inner walls of the adjacent first barrier rib 264a. The first barrier ribs 264a and the second barrier ribs 264b form a matrix by crossing with each other. Accordingly, the shape of a horizontal cross-section of each of the discharge cells is a rectangular shape.

Alternately, the barrier ribs 264 can be formed in various types such as for example, a meander type, a delta type, or a honeycomb type. However, the present embodiments are not limited to those types. Also, the discharge cells defined by the barrier ribs 264 can have any shape that can define the discharge cells other than the rectangular shape, such as, for example, a hexagonal shape, a circle shape, or an oval shape. However, the present embodiments are not limited to those shapes.

A discharge gas such as, for example, a Ne—Xe gas mixture or a He—Xe gas mixture is filled into the discharge cells defined by the first substrate 211, the second substrate 261, and the barrier ribs 264.

Phosphor layers 265 of red, green, and blue colour are formed in each discharge cell to emit visible light when the phosphor layers 265 are excited by ultraviolet rays generated from the discharge gas. The phosphor layers 265 can be coated in any region of the discharge cell. However, in the present embodiment, the phosphor layers 265 are coated on inner walls of the barrier ribs 264 and on an upper surface of the second dielectric layer 263 to a predetermined thickness.

The red, green, and blue color phosphor layers 265 are respectively coated in each discharge cell. The phosphor layer 265 of red color may be formed of (Y,Gd)BO₃;Eu⁺³, the phosphor layer 265 of green colour may be formed of Zn₂SiO₄:Mn²⁺, and the phosphor layer 265 of blue color may be formed of BaMgAl₁₀O₁₇:Eu²⁺.

In the present embodiment, the first discharge electrode lines 212 have a structure in which a plurality of sub-electrode lines that are connected to each other, and the second discharge electrode lines 213 which are disposed alternately with the first discharge electrode lines 212 also have a structure in which a plurality of sub-electrode lines are connected to each other. The first dielectric layer 214 that buries the first and second discharge electrode lines 212 and 213 includes a component of a particular material. The structures of the electrodes will now be described.

The first discharge electrode lines 212 extend along the X direction of the first substrate 211. Each of first discharge electrode lines 212 has a structure in which a plurality of sub-electrode lines 212a through 212c are connected to each other.

That is, the first discharge electrode lines 212 include first through third sub-electrode lines 212a through 212c disposed parallel and a predetermined distance apart from each other from a central region toward outside of each discharge cell.

The first through third sub-electrode lines 212a through 212c are formed in a strip shape, but the present embodiments are not limited thereto. Also, in the current embodiment, the first discharge electrode lines 212 include the first through third sub-electrode lines 212a through 212c, but the present embodiments are not limited thereto.

The first through third sub-electrode lines 212a through 212c are electrically connected to each other by a first bridge 212d disposed between the first and second sub-electrode lines 212a and 212b and a second bridge 212e disposed between the second and third sub-electrode lines 212b and 212c.

The first and second bridges 212d and 212e are respectively disposed in each discharge cell, but the present embodiments are not limited thereto. Also, the first and second bridges 212d and 212e are disposed linearly in a direction perpendicular to the first through third sub-electrode lines 212a through 212c, that is, along the Y direction of the first substrate 211.

The second discharge electrode lines 213 also extend along the X direction of the first substrate 211. The second discharge electrode lines 213 substantially have the same shape as the first discharge electrode lines 212, and are substantially symmetrically disposed in unit discharge cells.

The second discharge electrode lines 213 include stripe shaped fourth through sixth sub-electrode lines 213a through 213c disposed a predetermined distance apart from each other from a central region towards outside of each discharge cell

The fourth through sixth sub-electrode lines 213a through 213c are electrically connected to each other by a third bridge 213d disposed between the fourth sub-electrode line 213a and the fifth sub-electrode line 213b and a fourth bridge 213e disposed between the fifth sub-electrode line 213b and the sixth sub-electrode line 213c.

The third and fourth bridges 213d and 213e are disposed linearly in a direction perpendicular to the fourth through sixth sub-electrode lines 213a through 213c, and each of the third and fourth bridges 213d and 213e is disposed in each discharge cell, but the present embodiments are not limited thereto.

Also, in the current embodiment, the second discharge electrode lines 213 include the fourth through sixth sub-electrode lines 213a through 213c and of the third and fourth bridges 213d and 213e, but the present embodiments are not limited thereto. The first through third sub-electrode lines 212a through 212c and the fourth through sixth sub-electrode lines 213a through 213c may respectively have a line width of from about 20 to about 150 micrometers.

As the area of the first through third sub-electrode lines 212a through 212c and the fourth through sixth sub-electrode lines 213a through 213c increases, discharges can be generated smoothly, thus, the generation of visible light increases. However, as the area of the first through third sub-electrode lines 212a through 212c and the fourth through sixth sub-electrode lines 213a through 213c excessively increases, the aperture ratio decreases, thereby reducing overall brightness and unnecessarily increasing power consumption.

Also, the first discharge electrode lines 212 that include the first through third sub-electrode lines 212a through 212c and the first and second bridges 212d and 212e formed between the first through third sub-electrode lines 212a through 212c and the second discharge electrode lines 213 that include the fourth through sixth sub-electrode lines 213a through 213c and the third and fourth bridges 213d and 213e formed between the fourth through sixth sub-electrode lines 213a through 213c can be formed in a single layer structure as in the current embodiment, but may be formed in a double layer structure.

When the first discharge electrode lines 212 and the second discharge electrode lines 213 have a double layer structure, each layer can be formed of different material. Also, to simplify a manufacturing process, the first through third sub-electrode lines 212a through 212c and the first and second bridges 212d and 212e formed therebetween and the fourth through sixth sub-electrode lines 213a through 213c and the third and fourth bridges 213d and 213e formed therebetween may be simultaneously formed to a thick film using a printing method that uses a photosensitive paste or to a thin film using a sputtering method or a deposition method.

The first discharge electrode lines 212 and the second discharge electrode lines 213 can be formed of various conductive metals, that is, at least one selected from the group consisting of Ag, Pt, Ni, Cu, Pd or an alloy of these metals.

Alternately, the first discharge electrode lines 212 and the second discharge electrode lines 213 can be formed of a conductive ceramic material or a material including carbon nanotubes in order to increase the emission of secondary electrons.

In non-discharge regions between the discharge cells adjacent in the Y direction of the plasma display panel 200, light absorbing layers 216 such as black stripe layers are formed to increase a bright room contrast ratio, and thus, to increase optical characteristics of the plasma display panel 200. The light absorbing layers 216 extend along the X direction of the plasma display panel 200, and are disposed on the non-discharge regions corresponding to the first barrier ribs 264a.

The first discharge electrode lines 212, the second discharge electrode lines 213, and the light absorbing layer 216 are buried in the first dielectric layer 214. The first dielectric layer 214 is formed of a material that can prevent direct connection between the first discharge electrode lines 212 and the second discharge electrode lines 213, can prevent the first discharge electrode lines 212 and the second discharge electrode lines 213 from being damaged by direct collision with positive ions or electrons, and can accumulate wall charges by inducing charges.

The first dielectric layer 214 is formed of a high dielectric material that includes B₂O₃ and BaO in order to minimize the occurrence of yellowness by the diffusion of the metal ion such as Ag²⁺ included in the first discharge electrode lines 212 and the second discharge electrode lines 213 into the first dielectric layer 214. B₂O₃ and BaO are respectively mixed in the first dielectric layer 214 in the range from about 10 to about 60% of the total composition of the first dielectric layer 214.

Also, the first dielectric layer 214 may preferably include at least two materials selected from the group consisting of Al₂O₃, ZnO, SnO, and P₂O₅. At least one materials selected from the group consisting of Al₂O₃, ZnO, SnO, and P₂O₅ can be mixed in the first dielectric layer 214 in the range from about 10 to about 30% of the total composition of the first dielectric layer 214.

When the above materials are added to the first dielectric layer 214, during a firing process of the first dielectric layer 214, a thermal treatment temperature is reduced and, at the same time, firing viscosity is reduced, and thus, fine air bubbles in the first dielectric layer 214 can be removed. When air bubbles are removed, the dispersion rate of incident light into the first dielectric layer 214 decreases. Therefore, light transmittance of the first dielectric layer 214 increases, thereby increasing operation brightness of the plasma display panel 200.

A protective layer 215 is formed on a surface of the first dielectric layer 214 to prevent the first dielectric layer 214 from being damaged by collisions with positive ions and electrons during discharges, to increase light transmittance, and to be able to emit larger amounts of secondary electrons during discharges. The protective layer 215 is formed as a thin film type using a sputtering method or an electron beam deposition method.

In the case of the address electrode lines 262 disposed on the second substrate 261 and the second dielectric layer 263 that buries the address electrode lines 262, in order to prevent the diffusion of a metal atom that constitutes the address electrode lines 262 into the second dielectric layer 263, the second dielectric layer 263 also employs the same composition as the first dielectric layer 214.

An operation of the plasma display panel 200 having the above structure according to an embodiment will now be described.

When a predetermined voltage is applied between the second discharge electrode lines 213, which corresponds to the Y electrode, and the address electrode lines 262, wall charges are accumulated on the surface of the first dielectric layer 214. In this state, a sustain discharge is generated by applying an alternate current between the first discharge electrode lines 212, which corresponds to the X electrode, and the second discharge electrode lines 213.

The sustain discharge between the first discharge electrode lines 212 and the second discharge electrode lines 213 will be described in detail. When an alternating current voltage of about 180V is applied between the first discharge electrode lines 212 and the second discharge electrode lines 213, an initial discharge is generated between the first sub-electrode line 212a of the first discharge electrode lines 212 and the fourth sub-electrode line 213a of the second discharge electrode lines 213 disposed closest to the central region of the discharge cell where the discharge distance is relatively short. The discharge consecutively expands to the second and third sub-electrode lines 212b and 212c and the fifth and sixth sub-electrode lines 213b and 213c consecutively disposed toward the outside of the discharge cell. To ensure a stable initial discharge, the line width of the first sub-electrode line 212a and the fourth sub-electrode line 213a can be in the range from about 20 to about 150 micrometers.

In a state where charges are formed in a discharge space due to the initial discharge, a main discharge is generated by an alternating current voltage applied between the first discharge electrode lines 212 and the second discharge electrode lines 213. The formed charges and ultraviolet rays formed during the initial discharge facilitate the generation of the main discharge by accelerating an insulation breakage action of the discharge gas filled between the second and third sub-electrode lines 212b and 212c and the fifth and sixth sub-electrode lines 213b and the 213c consecutively disposed towards outside of the discharge cell.

The main discharge is generated by an alternate current voltage applied between the first discharge electrode lines 212 and the second discharge electrode lines 213 and ultraviolet rays are generated from the discharge gas while the energy level of the discharge gas is reduced due to level of the main discharge. The generated ultraviolet rays excite phosphor layers 265 formed at least on a surface of the discharge space defined by the barrier ribs 264 in order to emit visible light, and the emitted visible light displays predetermined numbers, letters, or graphics.

The plasma display panel according to the present embodiments provides the following advantages.

First, dielectric layers that bury discharge electrode lines include B₂O₃ and BaO, and thus, yellowing caused by the migration of a metal component included in the discharge electrode lines into the dielectric layers during a firing process can be prevented.

Second, the discharge electrode lines use an ITO-free type of electrode structure. Therefore, a manufacturing process is simple, thereby reducing manufacturing costs.

Third, since discharge electrode lines include a plurality of sub-electrode lines and bridges that electrically connect the discharge electrode lines, the initiation of a discharge is easy. An optimum brightness can be maintained by controlling thicknesses and widths of the discharge electrode lines.

While the present embodiments have been particularly shown and described with reference to exemplary embodiments thereof, it will be understood by those of ordinary skill in the art that various changes in form and details may be made therein without departing from the spirit and scope of the present embodiments as defined by the following claims.

What is claimed is:

1. A plasma display panel comprising:
a first substrate;
a second substrate facing the first substrate;
a pair of discharge electrode lines disposed between the first substrate and the second substrate, each formed by connecting a plurality of sub-electrode lines that comprise a first discharge electrode line and a second discharge electrode line that faces the first discharge electrode line; and
dielectric layers that bury the discharge electrode lines,
wherein the dielectric layers comprise B₂O₃ and BaO.

2. The plasma display panel of claim 1, wherein the content of B₂O₃ in the dielectric layers is from about 10 to about 60% of the total composition of the dielectric layers.

3. The plasma display panel of claim 1, wherein the content of BaO in the dielectric layers is from about 10 to about 60% of the total composition of the dielectric layers.

4. The plasma display panel of claim 1, wherein the dielectric layers comprise at least one material selected from the group consisting of Al₂O₃, ZnO, SnO, and P₂O₅.

5. The plasma display panel of claim 4, wherein the content of at least one material selected from the group consisting of Al₂O₃, ZnO, SnO, and P₂O₅ in the dielectric layers is from about 10 to about 30% of the total composition of the dielectric layers.

6. The plasma display panel of claim 1, wherein the sub-electrode lines of the first discharge electrode line extend in the direction of the first substrate and are electrically connected to each other, and the sub-electrode lines of the second discharge electrode line extend in the same direction as the first sub-electrode lines and are electrically connected to each other.

7. The plasma display panel of claim 6, wherein the sub-electrode lines of the first discharge electrode line comprise stripe shaped electrode lines disposed in parallel and are connected to each other by first bridges formed therebetween, and wherein the sub-electrode lines of the second discharge electrode line comprise stripe shaped electrode lines disposed in parallel and are connected to each other by second bridges formed therebetween.

8. The plasma display panel of claim 1, wherein the first discharge electrode line and the second discharge electrode line face each other in the discharge cell and are substantially symmetrical to each other.

9. The plasma display panel of claim 1, wherein the discharge electrode lines are formed of a conductive metal, a conductive ceramic material or carbon nanotubes.

10. The plasma display panel of claim 1, wherein a light absorbing layer is disposed between adjacent discharge cells.

11. The plasma display panel of claim 1, wherein the discharge electrode lines are ITO-free type electrodes.

12. A plasma display panel comprising:
a first substrate;
a second substrate facing the first substrate;
barrier ribs disposed between the first and second substrates in order to define a plurality of discharge cells;
a pair of sustain discharge electrode lines that comprise a first discharge electrode line that is disposed between the first and second substrates and is formed by connecting a plurality of sub-electrode lines and a second discharge electrode line that faces the first discharge electrode line and is formed by connecting a plurality of sub-electrode lines, wherein a sustain discharge is generated between the first discharge electrode line and the second discharge electrode line;
address electrode lines that cross the pair of sustain discharge electrode lines in order to generate address discharges with one of the first or second discharge electrode lines of the pair of sustain discharge electrode lines; and
dielectric layers that respectively bury the pair of sustain discharge electrode lines and the address electrode lines; and
phosphor layers of red, green, and blue color formed in the discharge cells,
wherein the dielectric layers comprise B₂O₃ and BaO.

13. The plasma display panel of claim 12, wherein the content of B₂O₃ in the dielectric layers is from about 10 to about 60% of the total composition of the dielectric layers.

14. The plasma display panel of claim 12, wherein the content of BaO in the dielectric layers is from about 10 to about 60% of the total composition of the dielectric layers.

15. The plasma display panel of claim 12, wherein the dielectric layers further comprise at least one material selected from the group consisting of Al₂O₃, ZnO, SnO, and P₂O₅.

16. The plasma display panel of claim 15, wherein the content of at least one material selected from the group consisting of Al₂O₃, ZnO, SnO, and P₂O₅ in the dielectric layers is from about 10 to about 30% of the total composition of the dielectric layers.

17. The plasma display panel of claim 12, wherein the sub-electrode lines of the first discharge electrode line extend in the direction of the first substrate and are electrically connected to each other, and wherein the sub-electrode lines of the second discharge electrode line extend in the same direction as the first sub-electrode lines and are electrically connected to each other, and wherein the address electrode lines cross the first and second discharge electrode lines.

18. The plasma display panel of claim 6, wherein the sub-electrode lines of the first discharge electrode line comprise stripe shaped electrode lines disposed in parallel and are connected to each other by first bridges formed therebetween, and the sub-electrode lines of the second discharge electrode line comprise two stripe shaped electrode lines disposed in parallel and are connected to each other by second bridges formed therebetween.

19. The plasma display panel of claim 12, wherein the discharge electrode lines are formed of a conductive metal, a conductive ceramic material, or carbon nanotubes.

20. The plasma display panel of claim 12, wherein a light absorbing layer is disposed between adjacent discharge cells.

21. The plasma display panel of claim 20, wherein the barrier ribs comprise first barrier ribs crossing the address electrode lines and second barrier ribs disposed parallel to the address electrode lines, wherein the second barrier ribs define discharge cells by extending from inner walls of the adjacent first barrier ribs towards each other.

22. The plasma display panel of claim 12, wherein the dielectric layers comprise a first dielectric layer that covers the pair of sustain discharge electrode lines and a second dielectric layer that covers the address electrode lines.

23. The plasma display panel of claim 12, wherein the pair of sustain discharge electrode lines and the address electrode lines are ITO-free type of electrodes.
